(19) United States
(12) Patent Application Publication
(10) Pub. No.: US 2006/0162942 A1
(43) Pub. Date: Jul. 27, 2006

(54) Nail gun extension handle

(76) Inventor: Jesse Martin, Radnor, OH (US)

Correspondence Address: DANE C. BUTZER, 870 HIGH STREET, SUITE 104, WORTHINGTON, OH, 43085, US

(21) Appl. No.: 11/040,965

(22) Filed: Jan. 22, 2005

(51) Int. Cl. B23B 45/00

(52) U.S. Cl. 173/1; 173/170

(57) ABSTRACT

An extension handle for a nail gun includes an extension piece that mounts to the nail gun, one or more handles that mount on the extension piece, a pull cable that connects to a trigger on the nail gun, and a pull ring attached to the pull cable such that pulling the pull ring pulls the trigger. In one embodiment, the extension handle further includes a mounting piece that mounts to the nail gun through a bolt in an end of the nail gun, and the extension piece mounts to the nail gun by attaching to the mounting piece. Preferably, the pull ring can be pulled from either of two handles. In another embodiment, at least one of the handles can be moved to an intermediate location on the extension piece.

### BACKGROUND OF THE INVENTION

1. Field of the Invention

This invention relates to an extension handle for a nail gun.

2. Description of the Related Art

Nail guns are invaluable tools for construction work. However, nail guns are not adapted for easy use in all settings. When a person uses a nail gun on a floor or subfloor, for example, the person might have to spend an extended period of time bent over. Working in a bent over position for any significant length of time is very tiring and uncomfortable and can even lead to injury.

One proposal for addressing these issues is an extension handle for a nail gun. An example of such a handle is disclosed in U.S. Pat. No. 5,509,489 (Lower). However, such extension handles have not found widespread acceptance in the market place.

One problem with existing extension handles is that they can be difficult to attach to a nail gun or do not attach securely. Given the inherent dangers of using a nail gun, insecure extension handles are simply unacceptable.

Another problem is that existing extension handles are awkward to use. An awkward extension handle defeats the entire purpose of using an extension handle, namely making use of a nail gun easier and more comfortable in an otherwise awkward setting.

### SUMMARY OF THE INVENTION

The invention addresses these problems with an extension handle for a nail gun. The extension handle includes an extension piece that mounts to the nail gun, one or more handles that mount on the extension piece, a pull cable that connects to a trigger on the nail gun, and a pull ring attached to the pull cable such that pulling the pull ring pulls the trigger.

In one embodiment, the extension handle also includes a mounting piece that mounts to the nail gun through a bolt in an end of the nail gun, and the extension piece mounts to the nail gun by attaching to the mounting piece. Preferably, the mounting piece includes a flange with an opening in which the pull cable is secured, and the extension piece is a hollow tube.

The extension handle preferably includes two handles that can be mounted at the top of the extension piece, and the pull ring preferably can be pulled from either of the handles.

In some embodiments, at least one of the handles can be moved to an intermediate location on the extension piece. In these embodiments, the extension handle preferably includes a second pull ring attached to the pull cable at the intermediate location such that pulling the second pull ring also pulls the trigger.

The invention also encompasses methods of using a nail gun with the extension handle.

This brief summary has been provided so that the nature of the invention may be understood quickly. A more complete understanding of the invention may be obtained by reference to the following description of the preferred embodiments thereof in connection with the attached drawings.

### BRIEF DESCRIPTION OF THE DRAWINGS

FIG. 1 shows an extension handle attached to a nail gun according to an embodiment of the invention.

FIG. 2 shows two handles for holding a pull ring according to an embodiment of the invention.

FIG. 3 shows a bolt by which an extension handle attaches to a nail gun according to an embodiment of the invention.

FIG. 4 shows a mounting piece that can be used with the arrangement shown in FIG. 3.

FIG. 5 shows one of the handles moved to an intermediate location on the extension piece according to an embodiment of the invention.

FIG. 6 shows a bolt that can be used to secure a handle at an intermediate location according to an embodiment of the invention.

### DESCRIPTION OF THE PREFERRED EMBODIMENTS

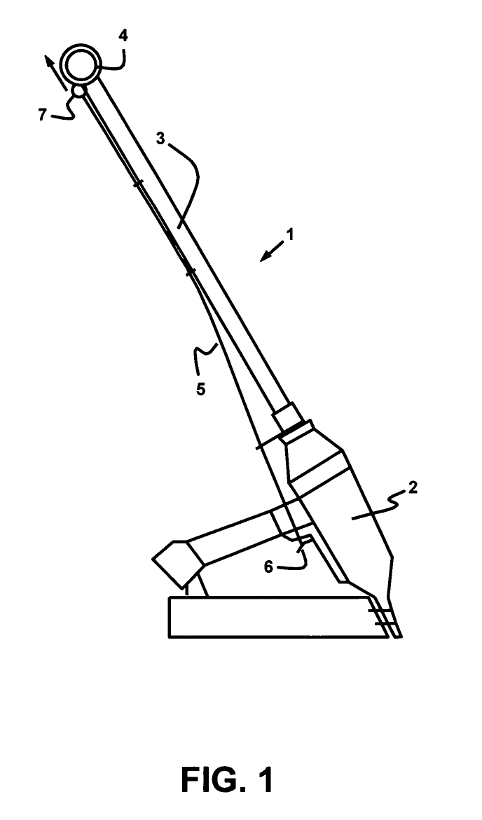

FIG. 1 shows an extension handle attached to a nail gun according to an embodiment of the invention.

Briefly, the extension handle includes an extension piece that mounts to the nail gun, one or more handles that mount on the extension piece, a pull cable that connects to a trigger on the nail gun, and a pull ring attached to the pull cable such that pulling the pull ring pulls the trigger.

Thus, FIG. 1 shows extension handle 1 attached to nail gun 2. The nail gun can be any type of nail gun, for example but not limited to nail guns manufactured by Senco®, Bostich®, Duo-Fast®, and Hitachi(®.

Extension handle 1 includes extension piece 3 that mounts to nail gun 2, one or more handles 4 that mount on the extension piece, pull cable 5 that connects to trigger 6 on nail gun 2, and pull ring 7 that is attached to pull cable 5 such that pulling pull ring 7 pulls trigger 6.

Extension piece 3 preferably is a hollow tube. In a preferred embodiment, the extension piece is a twenty-six inches long, one inch diameter, sixteen gauge piece of anodized and cleared hollow aluminum tubing. Other types and sizes of extension pieces made of different materials can be used. In addition, an adjustable extension piece can be used to provide greater flexibility.

Preferably, two handles 4 are provided on opposite sides of a top end of extension piece 3. The handles can be permanently mounted, for example welded on. Alternatively, one or both of the handles can be removable.

Pull cable 5 preferably is a sheathed cable such as a throttle cable or a bicycle brake cable. Other types of cables can be used. The cable can be secured to extension piece 3 using any suitable attachment, for example tie straps, eyelets or clips screwed into or riveted into extension piece 3, and the like.

One end of pull cable 5 is attached to trigger 6, for example by looping over the trigger. Other methods for attaching the cable to the trigger can be used.

Pull ring 7 is attached to the other end of pull cable 5. The pull ring is sized so that a person's finger can fit easily through the ring. A one and one quarter inch diameter ring has been found to work well. The pull ring preferably is circular in shape. Other sizes and shapes of pull rings can be used.

In use, a person attaches extension handle 1 to nail gun 2. As indicated by the arrow near pull ring 7 in FIG. 1, the person can then pull the pulls ring to fire the nail gun. The extension handle permits a standing person to use the nail gun on floors, subfloors and the like. The invention is not limited to these uses.

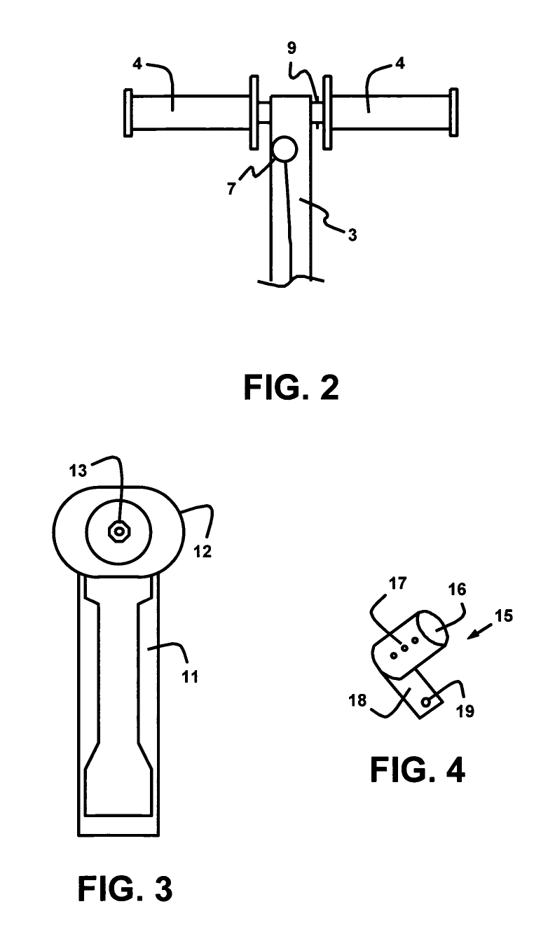

FIG. 2 shows two handles for holding a pull ring according to an embodiment of the invention. This figure illustrates one possible arrangement for handles 4 mounted at a top of extension piece 3. The handles can be permanently mounted, for example welded on. Alternatively, one or both of the handles can be removable. If one or both of the handles is removable, a pin such as pin 9 could be used to secure the handle(s). Other methods of securing the handle(s) can be used.

FIG. 2 illustrates that pull ring 7 can be conveniently pulled from either of the handles. This provides improved comfort and adaptability. For example, if a person's hand gets tired pulling the pull ring, the person can easily switch to using their other hand.

FIG. 3 shows a bolt by which an extension handle attaches to a nail gun according to an embodiment of the invention. Most nail guns include such a bolt at an end of the main body of the nail gun opposite a side that fires nails. Thus, FIG. 3 shows a top-down view of nail gun 11 with main body 12 and bolt 13. According to the invention, an extension handle can be mounted to the nail gun by removing bolt 13, placing a mounting piece on the nail gun, and then replacing bolt 13, thereby securing the mounting piece.

FIG. 4 shows a mounting piece that can be used with the arrangement shown in FIG. 3. Mounting piece 15 includes a cylindrical portion 16. The mounting piece also includes a hole in its bottom (not shown) for a bolt such as bolt 13.

An extension piece for an extension handle can be mounted to a nail gun by attaching to the mounting piece, for example by fitting snugly in cylindrical portion 16 of mounting piece 15. The cylindrical portion of the mounting piece can be any suitable size and shape. In one embodiment, the cylindrical portion is a two and one half inch tall piece of conduit with an interior diameter of one inch.

In some embodiments, holes 17 are provided in cylindrical portion 16 that align with holes in an extension piece (not shown). A pin placed through a set of these holes can be used to secure the extension piece to the mounting piece. In some embodiments, multiple sets of holes are provided, thereby permitting the extension piece to be secured at different positions.

Mounting piece 15 also preferably includes flange 18. This flange can be permanently mounted to cylindrical portion 16, for example welded on, although this need not be the case. In a preferred embodiment, flange 18 includes opening 19 in which a pull cable can be secured. A three and one half inch flange with a five sixteenths inch hole works well, although other sizes of flanges with different sized holes can be used.

Other sizes, types and shapes of mounting pieces can be used. In addition, the extension piece could be mounted directly on the nail gun without a separate mounting piece.

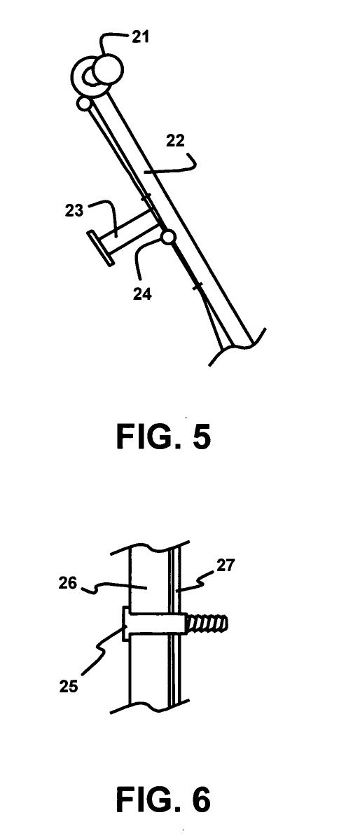

FIG. 5 shows one of the handles moved to an intermediate location on the extension piece according to an embodiment of the invention. This intermediate location can be used to mount a handle that has been removed from the top of the extension piece or to mount another separate handle, thereby providing for a different way to grip the overall apparatus.

The embodiment shown in FIG. 5 includes a first handle 21 mounted at a top of extension piece 22 and a second handle 23 mounted at an intermediate location. A location sixteen inches along the extension piece from the nail gun has been found to work well, although other locations can be used. One or more such intermediate locations can be provided.

In one embodiment, a bolt is provided at the intermediate location for mounting a handle. An example of such a bolt is shown in FIG. 6. Bolt 25 fits into a hole in extension piece 26. A portion of the bolt extends past the extension piece. The bolt includes a drilled hole for pull cable 27. This arrangement ensures that the pull cable stays centered on the extension piece, thereby reducing a risk of accidents that could be caused by a loose or free-floating cable.

The head of bolt 25 and pull cable 27 hold the bolt in place in the extension piece. At least a portion of the bolt is threaded as shown in FIG. 6. A handle can be secured to the extension piece by being screwed onto this threaded portion. The end of the threading or some other form of stop can be used to prevent the handle from being screwed on too far.

Other methods for mounting a handle at an intermediate location can be used.

In embodiments with an intermediate location for a handle, at least a second pull ring 24 preferably is provided. The second pull ring can be connected to the extension handle's pull cable so that pulling the second pull ring also pulls the nail gun's trigger. Alternatively, the second pull ring can use its own separate pull cable. Other arrangements are possible.

### Alternative Embodiments

The invention is in no way limited to the specifics of any particular preferred embodiment disclosed herein. Many variations are possible which remain within the content, scope and spirit of the invention, and these variations would become clear to those skilled in the art after perusal of this application.

What is claimed is:

1. An extension handle for a nail gun, comprising:
an extension piece that mounts to the nail gun;
one or more handles that mount on the extension piece;
a pull cable that connects to a trigger on the nail gun; and
a pull ring attached to the pull cable such that pulling the pull ring pulls the trigger.

2. An extension handle as in claim 1, further comprising a mounting piece that mounts to the nail gun through a bolt in an end of the nail gun, wherein the extension piece mounts to the nail gun by attaching to the mounting piece.

3. An extension handle as in claim 2, wherein the extension piece is a hollow tube.

4. An extension handle as in claim 2, wherein the mounting piece includes a flange with an opening in which the pull cable is secured.

5. An extension handle as in claim 1, wherein the handles include two handles that can be mounted at a top of the extension piece.

6. An extension handle as in claim 5, wherein the pull ring can be pulled from either of the handles.

7. An extension handle as in claim 1, wherein at least one of the handles can be moved to an intermediate location on the extension piece.

8. An extension handle as in claim 7, further comprising a second pull ring attached to the pull cable at the intermediate location such that pulling the second pull ring also pulls the trigger.

9. An extension handle as in claim 8, further comprising a bolt at the intermediate location to which one of the handles can be attached.

10. An extension handle as in claim 9, wherein the bolt includes a hole for the pull cable.

11. A method of using a nail gun, comprising the steps of:
attaching an extension handle to the nail gun, the extension handle including an extension piece that mounts to the nail gun, one or more handles that mount on the extension piece, a pull cable that connects to a trigger on the nail gun, and a pull ring attached to the pull cable such that pulling the pull ring pulls the trigger; and
pulling the pull ring to fire the nail gun.

12. A method as in claim 11, wherein the extension handle further comprises a mounting piece that mounts to the nail gun through a bolt in an end of the nail gun, and wherein the extension piece mounts to the nail gun by attaching to the mounting piece.

13. A method as in claim 12, wherein the extension piece is a hollow tube.

14. A method as in claim 12, wherein the mounting piece includes a flange with an opening in which the pull cable is secured.

15. A method as in claim 11, wherein the handles include two handles that can be mounted at a top of the extension piece.

16. A method as in claim 15, wherein the pull ring can be pulled from either of the handles.

17. A method as in claim 1 1, wherein at least one of the handles can be moved to an intermediate location on the extension piece.

18. A method as in claim 17, wherein the extension handle further comprises a second pull ring attached to the pull cable at the intermediate location such that pulling the second pull ring also pulls the trigger, and wherein the method further comprises the step of pulling the second pull ring to fire the nail gun.

19. A method as in claim 18, wherein the extension handle further comprises a bolt at the intermediate location to which one of the handles can be attached.

20. A method as in claim 19, wherein the bolt includes a hole for the pull cable.
